(19) United States
(12) Patent Application Publication
(10) Pub. No.: US 2026/0122153 A1
(43) Pub. Date: Apr. 30, 2026

(54) INTELLIGENT CONNECTIONLESS ARCHITECTURE FOR MASSIVE INTERNET-OF-THINGS (mIoT) IN A WIRELESS NETWORK

(71) Applicant: AT&T Intellectual Property I, L.P., Atlanta, GA (US)

(72) Inventors: Zhi Cui, Sugar Hill, GA (US); Paul Edward Smith, JR., Heath, TX (US); Adam Loddeke, Lewisville, TX (US)

(73) Assignee: AT&T Intellectual Property I, L.P., Atlanta, GA (US)

(21) Appl. No.: 18/929,691

(22) Filed: Oct. 29, 2024

(51) Int. Cl. H04L 69/22; H04L 45/00; H04L 45/74

(52) U.S. Cl. CPC H04L 69/22; H04L 45/72; H04L 45/74

(57) ABSTRACT

Aspects of the subject disclosure may include, for example, receiving a service request relating to an mIoT application, identifying service delivery and feature requirements, resulting in identified requirements, obtaining first information from an AIC regarding resources in access network(s), second information from a TIC regarding resources in transport network(s), and third information from a CIC regarding resources in core network(s), selecting a first resource in the access network(s), a second resource in the transport network(s), a third resource in the core network(s), and at least one treatment function, generating an SRH that identifies the first, second, and third resources and the at least one treatment function, and causing the SRH to be provided to the AIC to facilitate embedding of the SRH into packets relating to the mIoT application, thereby enabling connectionless E2E service delivery for the mIoT application. Other embodiments are disclosed.

### FIELD OF THE DISCLOSURE

The subject disclosure relates to intelligence-based connectionless packet/service delivery for massive Internet-of-Things (mIoT) applications.

### BACKGROUND

In future networks such as 6G and beyond, the number of connected devices is expected to grow exponentially, reaching tens of billions or more. A significant portion of these devices will be IoT devices, such as utility meter readers, sensors, and other low-power, low-data-rate devices. Current mobility network architectures rely on 3rd Generation Partnership Project (3GPP) tunnel/bearer-based connection-oriented designs. These architectures involve per-session tunnel creation and per-mobility event tunnel handling. The substantial signaling overhead associated with general packet radio service (GPRS) Tunneling Protocol (GTP) tunnel setup and teardown, as well as the states related to GTP tunnels that must be maintained across various parts of the mobile network, makes it economically infeasible to scale such connection-oriented architectures to support billions of IoT devices. As the number of IoT devices continues to surge, the inefficiencies and limitations of existing network architectures will therefore become increasingly apparent.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments of a platform that is capable of generating routing headers for facilitating mIoT application packet/service delivery in a connectionless manner. The platform may be implemented in a service orchestration and management (SMO) system—e.g., in a connectionless (CL) mIoT (CLmIoT) microservice application (rApp) within the SMO system. The platform may interface with network controllers of various network domains to obtain data regarding underlying network resource capabilities, availability, and/or conditions, and may leverage artificial intelligence (AI)/machine learning (ML)-enabled dynamic end-to-end (E2E) closed loop network control and optimization (or approximate optimization) to analyze the data to select (e.g., the best) routes for mIoT application packet/service delivery. For a given mIoT application, the platform may utilize a selected route to identify a segment router (SR) policy for creating a routing header that can be applied to the packets of (e.g., all) mIoT devices that are associated with the mIoT application. In exemplary embodiments, a routing header may be a Segment Routing Header (SRH) that uses enhanced mode Segment Routing over Internet Protocol (IP)v6 (SRv6) to support the connectionless architecture. Alternatives to SRv6 may include Multiprotocol Label Switching (MPLS) or Segment Routing with MPLS (SR-MPLS). In various embodiments, the platform may provide the SRH to an access network controller, which, in turn, may transmit (or signal) the SRH to a selected physical resource, such as a base station (e.g., a gNodeB) in an access network. In one or more embodiments, the access network controller may be or may include a radio access network (RAN) intelligent controller (RIC) according to Open-RAN (O-RAN) standards, in which case the RIC may signal the SRH over an E2 interface between the RIC and the base station.

Exemplary embodiments of the intelligent connectionless network architecture advantageously provide an efficient and scalable solution for supporting the impending massive influx of IoT devices in future networks, such as 6G and beyond. Leveraging AI/ML-enabled dynamic E2E closed-loop network control and improvement (or optimization or approximate optimization), the intelligent connectionless network architecture can dynamically adapt to real-time conditions, select the best routes with improved (or optimized or approximately optimized) resource allocation and service delivery, and create SRHs for packets that traverse different network domains. At a more granular level, the connectionless architecture allows IoT devices to send data packets independently without the need to establish and maintain dedicated connections or sessions. This stateless communication model treats each packet independently, which reduces or eliminates the need for the network to maintain state information about sessions or connections, thereby simplifying the data plane. As a result, the signaling overhead can be significantly reduced, making the network more robust, scalable, and efficient for delivering improved network performance for mIoT applications. The adoption of a common architecture and protocol that enables unified wireless and wireline connectivity also simplifies the network infrastructure by not only streamlining network management but also enhancing network performance and reliability.

One or more aspects of the subject disclosure include a device, comprising a processing system including a processor, and a memory that stores executable instructions that, when executed by the processing system, facilitate performance of operations. The operations can include receiving a service request relating to a massive Internet-of-Things (mIoT) application. Further, the operations can include identifying service delivery requirements and feature requirements for the service request, resulting in identified requirements. Further, the operations can include obtaining first information from an access intelligent controller (AIC) regarding resources in one or more access networks, second information from a transport intelligent controller (TIC) regarding resources in one or more transport networks, and third information from a core intelligent controller (CIC) regarding resources in one or more core networks. Further, the operations can include based on the identified requirements, the first information, the second information, and the third information, selecting a first resource in the one or more access networks, a second resource in the one or more transport networks, a third resource in the one or more core networks, and at least one treatment function. Further, the operations can include generating a segment router header (SRH) that identifies the first, second, and third resources and the at least one treatment function. Further, the operations can include causing the SRH to be provided to the AIC to facilitate embedding of the SRH into packets relating to the mIoT application, thereby enabling connectionless end-to-end (E2E) service delivery for the mIoT application.

One or more aspects of the subject disclosure include a non-transitory machine-readable medium, comprising executable instructions that, when executed by a processing system including a processor, facilitate performance of operations. The operations can include receiving a service request relating to a massive Internet-of-Things (mIoT) application. Further, the operations can include identifying end-to-end (E2E) service delivery requirements for the service request, resulting in identified requirements. Further, the operations can include obtaining information from a plurality of network controllers regarding resources in a plurality of networks associated with the plurality of network controllers. Further, the operations can include based on the identified requirements and the information, selecting at least one treatment function and a plurality of resources in the plurality of networks. Further, the operations can include generating a segment router header (SRH) that identifies the at least one treatment function and the plurality of resources. Further, the operations can include transmitting the SRH to a first network controller of the plurality of network controllers, wherein the transmitting causes the first network controller to instruct a first resource of the plurality of resources to add the SRH to packets relating to the mIoT application so as to enable connectionless E2E service delivery for the mIoT application.

One or more aspects of the subject disclosure include a method. The method can comprise providing, by a processing system including a processor, and to a service management and orchestration (SMO) system, information regarding resources in one or more networks. Further, the method can include based on the providing, receiving, by the processing system and from the SMO system, a segment router header (SRH) that identifies at least one treatment function and a plurality of resources, wherein the plurality of resources includes one or more resources in the one or more networks and one or more other resources in one or more other networks, wherein the at least one treatment function is implemented in the processing system or another processing system, and wherein the SRH is generated by the SMO system according to the information and according to service requirements and feature requirements for a service request relating to a massive Internet-of-Things (mIoT) application. Further, the method can include responsive to the receiving, instructing, by the processing system, a first resource of the plurality of resources to embed the SRH into packets relating to the mIoT application, thereby enabling connectionless end-to-end (E2E) service delivery for the mIoT application.

Other embodiments are described in the subject disclosure.

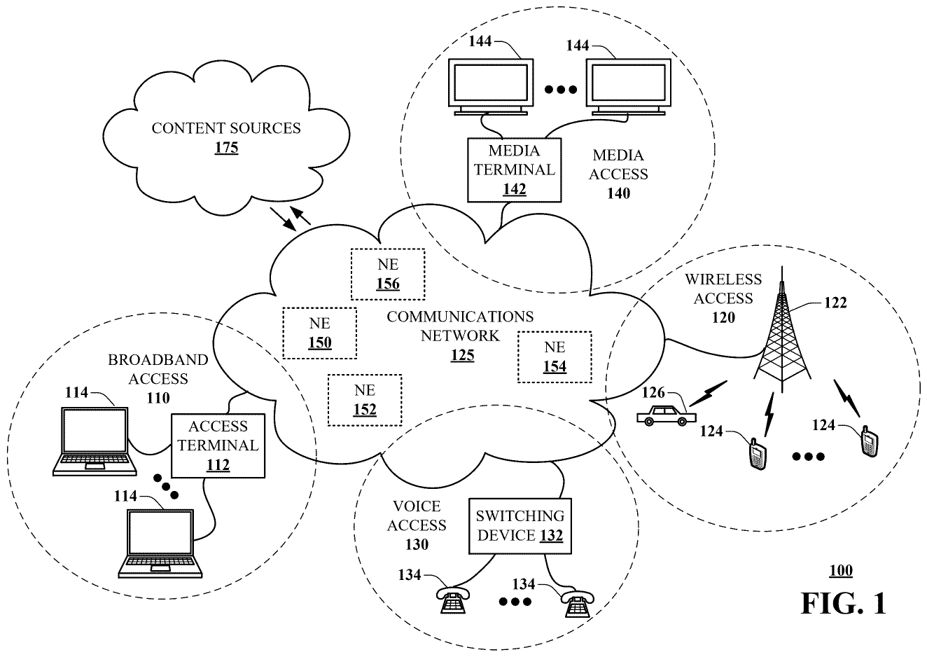

Referring now to FIG. 1, a block diagram is shown illustrating an example, non-limiting embodiment of a system 100 in accordance with various aspects described herein. For example, system 100 can facilitate, in whole or in part, intelligence-based connectionless packet/service delivery for mIoT applications. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

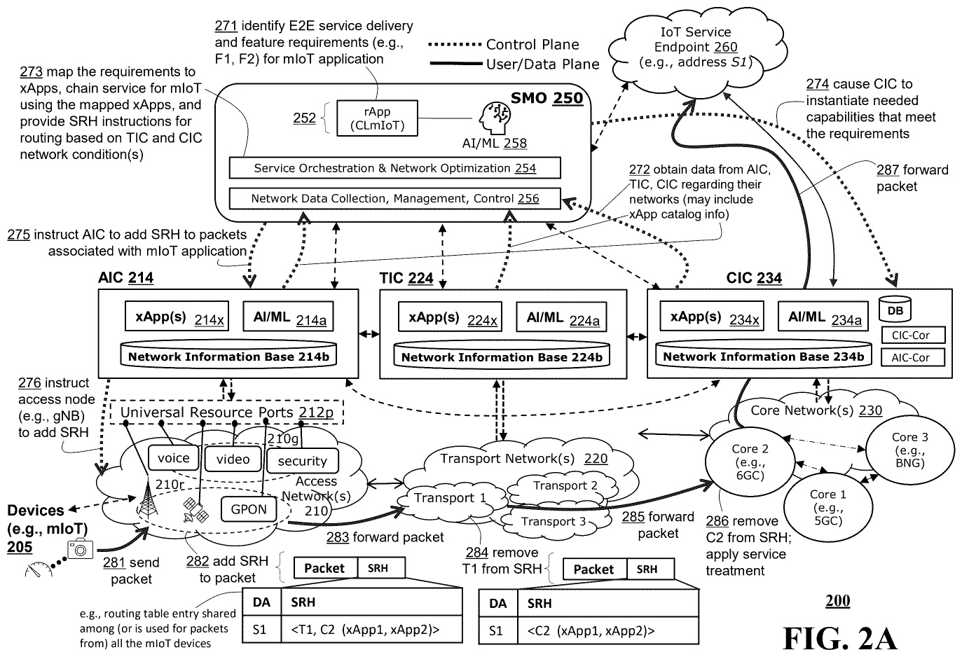

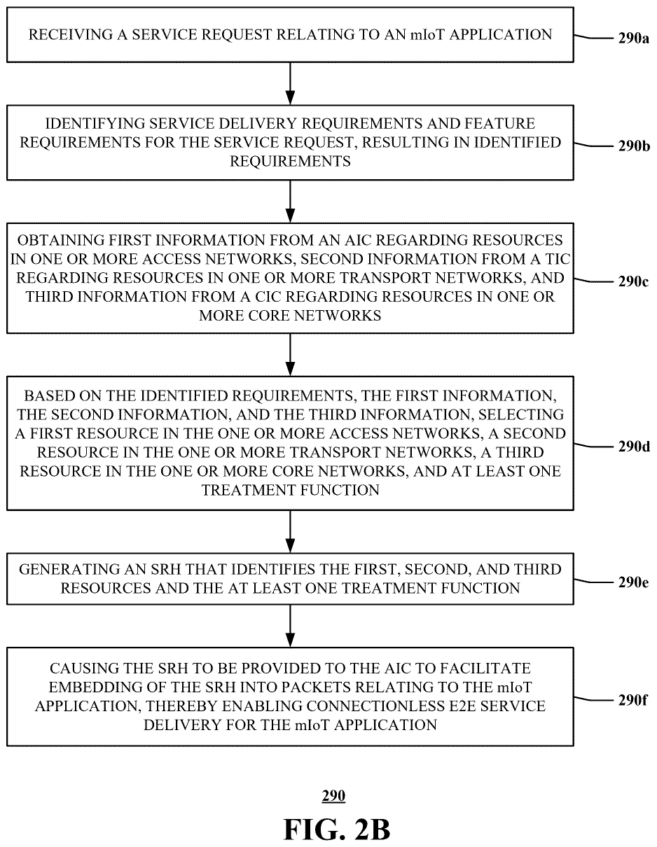

FIG. 2A is a block diagram illustrating an example, non-limiting embodiment of a system 200 functioning within, or operatively overlaid upon, the communications network 100 of FIG. 1 in accordance with various aspects described herein. The network system 200 may include access network(s) 210 (e.g., wireless RAN(s), Wi-Fi network(s), and/or wireline network(s)), transport (or backhaul) network(s) 220, and core network(s) 230.

The access network(s) 210 may include network resources, such as one or more physical resources (or network nodes) 210r and one or more logical resources 210g. The physical resources 210r may include base station(s), such as one or more eNodeBs (eNBs), one or more gNodeBs (gNBs), and/or the like. In various embodiments, the physical resources 210r may additionally, or alternatively, include one or more satellites and/or uncrewed aerial vehicles (UAVs), one or more Gigabyte Passive Optical Networks (GPONs) and/or related components (e.g., Optical Line Terminal(s) (OLT), Optical Network Unit(s) (ONU), etc.), and/or the like. A base station may employ any suitable radio access technology (RAT), such as long term evolution (LTE), 5G, 6G, or any higher generation RAT. In various embodiments, the access network(s) 210 can include various types of heterogeneous cell configurations with various quantities of cells and/or types of cells. The logical resources 210g may include voice service system(s) (e.g., a hardware and/or software implementation of voice-related functions), video service system(s) (e.g., a hardware and/or software implementation of video-related functions, such as coder-decoder or compression-decompression (CODEC) components or the like), security service system(s) (e.g., a hardware and/or software implementation of security-related functions), and/or the like.

The access network(s) 210 may be in communication with the core network(s) 230 via intermediate links provided by the backhaul or transport network(s) 220. The transport network(s) 220 may include traditional transport network technologies, such as optical fibers, microwave links, wireless point-to-point technologies, etc. In some embodiments, the transport network(s) 220 may additionally, or alternatively, include access-based technologies, such as PON, Integrated Access Backhaul (IAB), etc. In certain embodiments, the transport network(s) 220 may additionally, or alternatively, include core-based technologies, such as an evolved packet core (EPC) (associated with a mobility management entity (MME)), a 5G core (5GC) (associated with an SMF), a 6G core (6GC) (associated with a control plane function (CPF)), and/or a Broadband Network Gateway (BNG).

The core network(s) 230 may include various network devices and/or systems that provide a variety of functions. Examples of functions provided by, or included, in the core network(s) 230 include an access mobility and management function (AMF) configured to facilitate mobility management in a control plane of the network system 200, a User Plane Function (UPF) configured to provide access to a data network (such as a packet data network (PDN) in a user (or data) plane of the network system 200), a Unified Data Management (UDM) function, a Session Management Function (SMF), a Policy Control Function (PCF), and/or the like. For instance, the core network(s) 230 may include an EPC, a 5GC, a 6GC, and/or a BNG. In various embodiments, the core network(s) 230 may include one or more devices implementing other functions, such as a master user database server device for network access management, a PDN gateway server device for facilitating access to a PDN, and/or the like. The core network(s) 230 may be in further communication with one or more other networks (e.g., one or more content delivery networks (CDNs)), one or more services, and/or one or more devices. In one or more embodiments, some or all of the core network(s) 230 may be distributed cores.

It is to be understood and appreciated that the network system 200 can include any number/type of access network (e.g., any number/type of physical resources 210r and/or logical resources 210g), any number/type of transport network (e.g., any number/type of intermediate links), and any number/type of core network (e.g., any number/type of cores, interfaces, etc.), and thus the number/types of these networks and their components illustrated in, or described with respect to, FIG. 2A are for illustrative purposes only.

The network system 200 can facilitate service delivery for various types of devices 205, such as IoT (or mIoT) devices 205. As an example, the devices 205 may include meter readers (e.g., electricity, water, and/or gas meters for monitoring and billing), sensors or trackers (e.g., environmental, asset tracking, or agricultural sensors or the like), other low-power, low-data-rate devices, a similar type of device, or a combination of some or all of these devices. As another example, the devices 205 may include user equipment (UEs), such as a communication and/or computing device, which may include a mobile phone (e.g., a smart phone, a radiotelephone, etc.), a desktop computer, a laptop computer, a tablet computer, a handheld computer, a display device, a gaming device, a wearable communication device (e.g., a smart wristwatch, a pair of smart eyeglasses, AR-/VR-/MR-related gear (e.g., a pair of glasses or googles, a headset, a hat, glove(s), a mask, a jacket, a sock or shoe, a pair of pants or shorts, headphones, and/or the like), etc.), a similar type of device, or a combination of some or all of these devices. The devices 205 can be equipped with one or more transmitter (Tx) devices and/or one or more receiver (Rx) devices configured to communicate with, and utilize network resources of, the network system 200.

As depicted in FIG. 2A, the network system 200 may include an access network intelligent controller (AIC) 214 that interfaces an SMO system 250 and the access network(s) 210. In various embodiments, the AIC 214 may be capable of providing real-time (or near real-time) microservices associated with the access network(s) 210, and may be leveraged to select the (e.g., most appropriate) access technology or technologies that meet the needs of requested services. As shown, the AIC 214 may include one or more applications (xApps) 214x, an AI/ML system 214a (which may be implemented in an xApp as well), and a network information database 214b. The AI/ML system 214a may be configured to analyze (e.g., real-time or near real-time) network conditions in the access network(s) 210 and predict future network states to improve (or optimize or approximately optimize) resource allocation and service delivery. The AI/ML system 214a may utilize ML algorithms to identify patterns and anomalies in network traffic across the access network(s) 210 to enable proactive management and self-healing of the network(s). The network information database 214b may store information regarding the various physical resources 210r and/or logical resources 210g, including information regarding load conditions associated with those resources, availability of those resources, and/or the like; some or all of this information may be accessible to the xApp(s) 214x and/or the AI/ML system 214a.

Although not illustrated in FIG. 2A, in certain embodiments, portion(s) of the access network(s) 210 may be, or may include, a virtual RAN (vRAN) (e.g., in an O-RAN-based implementation) in which software is decoupled from hardware and implementation thereof is in accordance with principles of network function virtualization (NFV), where the control plane is separated from the data plane. In these embodiments, the vRAN may include a centralized set of baseband units located remotely from antennas and remote radio units, may be configured to share signaling amongst cells, and may provide control and service delivery optimization (or approximate optimization) functions. Here, the AIC 214 may include RIC functionality—i.e., a second RIC portion that is at least partially implemented in the xApps 214x, including, for instance, the AI/ML system 214a. In various embodiments, the AIC 214 may coordinate with a first RIC portion that is implemented, or otherwise incorporated, in a network service management platform (e.g., such as in one or more RAN applications (rApps) in the SMO system 250 and/or another system). The AIC 214 may include a second RIC portion having a centralized unit (CU) (e.g., a base station CU, such as a gNB CU or the like) that provides a CU applications layer as well as a CU control plane CU-CP and a CU user plane CU-UP. The particular functions performed by the two RIC portions can vary based on various criteria, including requirements of the network, and can also include redundancy and/or dynamic switching of functions (including functions described herein) between the two RIC portions. Additionally, the vRAN may include distributed units (DUs)—i.e., baseband units (e.g., base station DUs, such as gNB DUs or the like) configured to perform signal processing, UE scheduling, and/or the like, where each of DUs may be implemented as a virtual DU (vDU). Further, the vRAN may also include remote radio heads or remote units (RUs) for communicative coupling (e.g., via an air interface) with the devices 205. The RUs, the DUs, and the CU may, by way of a fronthaul (e.g., having open standards, such as O-RAN standards or the like), a midhaul, and a backhaul (e.g., portion(s) of the transport network(s) 220), provide (e.g., controlled) connectivity between the devices 205 and (e.g., portion(s) of) the core network(s) 230. The network service management platform and/or the first RIC portion may be operative at or in non-real-time; the second RIC portion and/or the CU may be operative at or in near-real-time; and the DUs, the RUs, and/or the devices 205 may be operative at or in real-time. As the terms (and related terms) are used herein, real-time operations may occur over a span of fractions of a second up to a second (or the like), near-real-time operations may occur over the course of a few seconds (e.g., 1 to 5 seconds or the like), and non-real-time operations may occur over a time period that is greater than a few seconds (e.g., greater than 5 seconds or the like). The network service management platform may manage, or otherwise adapt, RIC behaviors and/or operations across one or more of the three time zones or timeframes described above (e.g., real-time, near-real-time, and non-real-time) on an individualized and/or collective basis. Such management or adaptation of RIC behaviors and/or operations may conform to one or more models or microservices (e.g., AI models or microservices), as described herein. In turn, the RIC portions may establish and/or modify policies and/or behaviors of respective CUs, DUs, and RUs in accordance with the model(s) or microservice(s). In this regard, the network service management platform may indirectly influence the behaviors and/or operations of CUs, DUs, and/or RUs via one or more of the RIC portions. The communication channels and/or links between the vRAN and the devices 205 may include wireless links. For example, some or all of the devices 205 may be mobile, and may therefore enter and/or exit a service or coverage area associated with the vRAN. Also, some of the devices 205 may include non-mobile or stationary devices. The vRAN may thus include one or more routers, gateways, modems, cables, wires, and/or the like, and the communication channels and/or links between the vRAN and the non-mobile or stationary devices 205 may include wired/wireline links, optical links, etc. In certain embodiments, the second RIC portion may store, execute, and/or deploy in or via an applications layer (e.g., the aforementioned CU applications layer), applications or microservices (e.g., the xApps 214x or the like) that are configured to control and manage the vRAN. The applications or microservices may relate to scheduler capacity optimization, coverage optimization, capacity optimization (including, for example, via interference mitigation), user quality optimization (including, for example, for an uplink (UL) and/or a downlink (DL)), radio connection management, mobility management, quality-of-service (QoS) management, interference management, and/or the like. One or more of the RIC portions may also be configured to execute, or otherwise deploy, models, such as AI (e.g., ML) models that, when executed in one or more containers, provide corresponding microservices. Deployment of a microservice, such as an AI model or microservice, in the RIC portion(s) may involve, or include, for example, executing or instantiating the AI model in one or more containers in the applications layer of the RIC (e.g., the aforementioned CU applications layer), such that the AI model processes inputs (e.g., received from other microservices running on the RIC and/or from various components of the vRAN, such as the CU-CP & CU-UP, the DUs, and/or the RUs) and provides outputs (e.g., to the other microservices and/or the various components of the vRAN), in accordance with the AI model, to control the overall operation of the vRAN. Examples of microservices provided by AI model(s) can include those relating to scheduler capacity optimization, coverage optimization, capacity optimization (including, for example, via interference mitigation), user quality optimization (including, for example, for the UL and/or the DL), telemetry, network traffic control and/or management, device admissions (e.g., UE admissions control), and/or the like.

In exemplary embodiments, the AIC 214 may not only have RIC-like functionality for managing wireless-based network resources, but may also have functionality for managing wireline-based network resources in a manner that supports wirelines wireless convergence (WWC). In this sense, the AIC 214 may thus operate as a “general”access network controller.

As illustrated in FIG. 2A, the network system 200 may also include a transport network intelligent controller (TIC) 224 that interfaces the SMO system 250 and the transport network(s) 220. In various embodiments, the TIC 224 may be capable of providing real-time (or near real-time) microservices associated with the transport network(s) 220, and may be leveraged to select the (e.g., most appropriate) transport network(s) or link(s) that meet the needs of requested services.

The TIC 224 may include various applications (xApps) 224x, an AI/ML system 224a (which may be implemented in an xApp as well), and a network information database 224b. The AI/ML system 224a may be configured to analyze (e.g., real-time or near real-time) network conditions in the transport network(s) 220 and predict future network states to improve (or optimize or approximately optimized) resource allocation and service delivery. The AI/ML system 224a may utilize ML algorithms to identify patterns and anomalies in network traffic across the transport network(s) 220 to enable proactive management and self-healing of the network(s). The network information database 224b may store information regarding the various physical resources, including information regarding load conditions associated with those resources, availability of those resources, and/or the like; some or all of this information may be accessible to the xApp(s) 224x and/or the AI/ML system 224a.

As illustrated in FIG. 2A, the network system 200 may also include a core network intelligent controller (CIC) 234 that interfaces the SMO system 250 and the core network(s) 230. In various embodiments, the CIC 234 may be capable of providing real-time (or near real-time) microservices associated with the core network(s) 230 (which may include distributed cores), and may be leveraged to select the (e.g., most appropriate) core network(s) or instance(s) that meet the needs of requested services. In one or more embodiments, the CIC 234 may be configured with (e.g., operator specified or intended) policies and control functions for core network optimization (or approximate optimization) and efficiency/flexibility and for managing quality of experience (QoE).

The CIC 234 may include various applications (xApps) 234x, an AI/ML system 234a (which may be implemented in an xApp as well), and a network information database 234b. The AI/ML system 234a may be configured to analyze (e.g., real-time or near real-time) network conditions in the core network(s) 230 and predict future network states to improve (or optimize or approximately optimize) resource allocation and service delivery. The AI/ML system 234a may utilize ML algorithms to identify patterns and anomalies in network traffic across the core network(s) 230 to enable proactive management and self-healing of the network(s). The network information database 234b may store information regarding the various physical resources, including information regarding load conditions associated with those resources, availability of those resources, and/or the like; some or all of this information may be accessible to the xApp(s) 234x and/or the AI/ML system 234a.

The CIC 234 may also include a CIC coordinator (CIC-Cor) that is configured to communicate with other CICs (not shown), an AIC coordinator (AIC-Cor) that is configured to communicate with the AIC 214, and one or more databases (DB) for storing various data. The AIC-Cor may facilitate service coordination between the CIC 234 and the AIC 214 as needed.

Although not shown, the network system 200 may include an access resource abstraction layer or system that is configured to provide abstractions of the physical resources 210r and/or logical resources 210g. In various embodiments, the abstraction may be implemented in software or logical constructs that manage and represent the resources in a more flexible and interoperable manner. For instance, the abstraction process may be implemented through software mechanisms that create a virtual representation of the resources.

In exemplary embodiments, the physical resources 210r and/or logical resources 210g may be disaggregated into modular units so as to allow for more granular control and management. Information regarding the disaggregation may be used by the access resource abstraction layer as part of abstraction of the physical resources 210r and/or logical resources 210g into universal resource ports 212p. For example, a given access network 210 may include a network of gNBs which can be disaggregated into individual gNBs. Disaggregation may involve identifying each gNB's name, location (e.g., geographic area, zone, global positioning system (GPS) coordinates, and/or the like), capabilities or supported technologies (e.g., operational frequency range(s), RAT, fiber mode(s), speed, bandwidth, capacity, protocols, operational status, operational limits, etc.), devices or identifiers of devices that the gNB is directly coupled to, and/or the like. Some or all of this information may be used by the access resource abstraction layer as part of abstracting the gNB resources into corresponding universal resource ports 212p. As another example, the same access network 210 or another access network 210 may include multiple fiber links which can be similarly disaggregated into individual fiber links.

In various embodiments, the abstractions by the access resource abstraction layer may be from Layer 2 (e.g., Ethernet or data link layer) and above in the Open Systems Interconnection (OSI) model. The physical resources 210r and/or logical resources 210g may be abstracted to descriptor object(s) that identify the physical resources 210r and/or logical resources 210g and the corresponding universal resource ports 212p. In one or more embodiments, the access resource abstraction layer 212 may provide a descriptor object for each physical/logical resource and the corresponding universal resource port 212p.

In one or more embodiments, the AIC 214 may be configured to dynamically select abstracted physical/logical resources of the underlying access network(s) 210 to facilitate composition of access network modules and connectivities for packet/service delivery across the access network(s) that support service handling requests from the SMO system 250. Modularization of physical resources 210r (e.g., including both wireline and wireless network resources) and abstraction thereof into universal resource ports 212p advantageously allows the SMO system 250 to perform higher-layer service orchestration and network management across the underlying access network(s) 210 using any type of network technology (wireline and/or wireless) that meets service requirements, which provides a flexible, unified, and interoperable network architecture.

Although not illustrated in FIG. 2A, the network system 200 may similarly include a transport resource abstraction layer or system and a core resource abstraction layer or system. In exemplary embodiments, the transport resource abstraction layer may, similar to that described above with respect to the access resource abstraction layer, be configured to provide abstractions of the resources/devices/components in the transport network(s) 220 as universal resource ports based on disaggregation of the resources/devices/components. The TIC 224 may, similar to that described above with respect to the AIC 214, be configured to dynamically select abstracted physical resources of the corresponding underlying transport network(s) 220 to support service handling requests from the SMO system 250. In a case where the transport network(s) 220 include a mixture of traditional transport technologies (e.g., fiber-based or wireless-based technologies) and access-based technologies, such as PON or IAB, the modularization and abstraction of such transport resources advantageously supports access and transport convergence. In a case where the transport network(s) 220 include a mixture of traditional transport technologies (e.g., fiber-based or wireless-based technologies) and core-based technologies, such as EPC, 5GC, 6GC, and/or BNG, the modularization and abstraction of such transport resources advantageously support transport and core convergence.

In one or more embodiments, the core resource abstraction layer may, similar to that described above with respect to the access resource abstraction layer, be configured to provide abstractions of the resources/devices/components in the core network(s) 230 as universal resource ports based on disaggregation of the resources/devices/components. The CIC 234 may, similar to that described above with respect to the AIC 214, be configured to dynamically select abstracted physical resources of the corresponding underlying core network(s) 230 to support service handling requests from the SMO system 250.

As illustrated in FIG. 2A, the SMO system 250, which can be implemented in one or more computing devices or servers, may include rApp(s) 252, a service orchestration and network optimization block 254, and a network data collection, management, and control block 256. In various embodiments, the SMO system 250 may be capable of communicating with the AIC 214, the TIC 224, and/or the CIC 234 (e.g., via application programming interface (API) calls or the like) to obtain data regarding (e.g., the availability and the load conditions of) the resources in the various access network(s) 210, transport network(s) 220, and/or core network(s) 230. In one or more embodiments, the SMO system 250 may be capable of polling the AIC 214, the TIC 224, and/or the CIC 234 for the necessary data or may be notified of state changes or updates (e.g., based on load condition(s) or resource availability satisfying threshold(s)).

In various embodiments, the rApp(s) 252 may include specialized software modules (or microservices) that are configured to perform service management-related functions, such as, for instance, service integrity detection, self-healing, optimization (e.g., approximate optimization), service orchestration, network data collection and management, security management, QoS management, and/or the like. Service integrity detection may involve monitoring the integrity of services across the network to detect issues that affect service quality, such as network faults, performance degradation, or anomalies in service delivery. Self-healing may involve performing actions to correct detected issues, such as rerouting traffic, reallocating resources, or restarting failed components to restore normal service operation and reduce or minimize downtime. Optimization, or approximate optimization, may involve analyzing data to identify opportunities for load balancing, resource allocation, and traffic management, and making real-time adjustments to improve network efficiency and performance. Service orchestration may involve coordinating the deployment and management of services to ensure proper resource allocation and configuration. Network data collection and management may involve gathering and managing data from network elements to provide information to other rApps 252 for informed decision-making and effective network management. Security management may involve monitoring for threats, enforcing policies, and mitigating risks to ensure network and service security. QoS management may involve monitoring performance, enforcing QoS policies, and making adjustments to maintain consistent and reliable service quality for users. In certain embodiments, one or more of the rApps 252 may communicate with various components of the network to gather data, make intelligent decisions, and/or execute actions to maintain or improve service quality. In one or more embodiments, one or more of the rApps 252 may interact with the service orchestration and network optimization block 254 and the network data collection, management, and control block 256 to ensure efficient and reliable service delivery.

In one or more embodiments, the service orchestration and network optimization block 254 may be configured to provide association/mapping between service requirements and physical network resources, and may interact with the network data collection, management, and control block 256, the AIC 214, the TIC 224, the CIC 234, and/or the rApp(s) 252 to facilitate service instantiation and service/network resource chaining to meet the needs of requested services. In various embodiments, the service orchestration and network optimization block 254 may be configured to communicate with the rApps 252 to implement routing policies and make real-time adjustments based on network conditions and service demands. In one or more embodiments, the network data collection, management, and control block 256 may be configured to gather and manage data from network elements across the access network(s) 210, the transport network(s) 220, and the core networks (230). This data may include performance metrics, fault information, and/or other relevant parameters that are essential for effective network management. The network data collection, management, and control block 256 may provide the necessary data to the rApps 252 and/or the service orchestration and network optimization block 254 so as to enable these functions to make informed decisions and take appropriate actions to maintain service integrity and improve (or optimize or approximately optimize) network performance.

In exemplary embodiments, one or more of the rApps 252—e.g., a CLmIoT rApp 252—may include specialized software modules (or microservices) that are configured to facilitate E2E service delivery and feature composition for mIoT applications. The CLmIoT rApp 252 may be configured to manage the connectionless architecture for mIoT applications. This may involve handling the routing and service chaining of data packets for mIoT devices 205 without the need for establishing and maintaining dedicated connections or sessions. The CLmIoT rApp 252 may be capable of identifying features or functions (e.g., which may be referred to as F1, F2, etc.) for mIoT applications based on feature requirements. These features or functions may represent specific capabilities or services that are provided by particular xApp(s) 214x in the AIC 214, particular xApp(s) 224x in the TIC 224, and/or particular xApp(s) 234x in the CIC 234. For example, a given service request relating to mIoT devices 205 may include data processing, security checks, or specific application logic, which may be associated with requirements for data analysis or security management that one or more xApp(s) 234x in the CIC 234 may be capable of performing. In this example, the CLmIoT rApp 252 may utilize these xApp(s) to ensure that the feature requirements are met efficiently and effectively.

The SMO system 250 may include AI/ML 258 functionality that is configured to analyze (e.g., real-time or near real-time) network conditions and predict future network states for improving (or optimizing or approximately optimizing) resource allocation and service delivery. The AI/ML system 258 may utilize ML algorithms to identify patterns and anomalies in network traffic so as to enable proactive management and self-healing. For instance, the AI/ML system 258 may be trained to determine or predict optimal (or approximately optimal) routing paths, predict potential network congestion, and recommend resource allocation strategies to ensure efficient service delivery. In exemplary embodiments, the AI/ML system 258 may be trained to analyze service requests to identify E2E service delivery requirements and/or feature requirements for mIoT applications. In one or more embodiments, the AI/ML system 258 may be trained to make recommendations of resources based on key performance indicators (KPIs), such as latency, packet loss, and/or jitter. The AI/ML system 258 may assist the CLmIoT rApp 252 by identifying the specific service requirements of a service request, such as, for instance, an electric utility company needing data from electric meter devices 205. The AI/ML system 258 may analyze the service request to determine or predict the necessary data collection intervals, security requirements, and/or data processing needs, and may recommend appropriate xApp(s) in the AIC 214, the TIC 224, and/or the CIC 234 as well as appropriate routing paths to fulfill these requirements. As an example, in a case where an electric utility company requires data from electric meter devices 205, the packets may not need to be transmitted quickly and may be infrequent. In such a scenario, the AI/ML system 258 may be trained to acceptably select even access network resources, transport network resources, and core network resources that are loaded above a certain threshold level but that have sufficient bandwidth to meet service requirements. Conversely, for packets related to video sensor data, which may involve large amounts of data and require low latency, the AI/ML system 258 may be trained to acceptably select only access network resources, transport network resources, and core network resources that are not loaded above the threshold level so as to ensure timely packet delivery. As another example, if the electric utility service requires enhanced security, the AI/ML system 258 may recommend the use of a security xApp in the core network to provide secure treatment or processing of the packets. In contrast, for video monitoring applications where security may not be a primary concern, but where the quality of the video packets needs to be enhanced, the AI/ML system 258 may recommend the use of one or more video processing xApps in the core network. In a scenario where latency is a critical factor, such as in real-time video monitoring, the AI/ML system 258 may prioritize the selection of network resources that exhibit low latency (e.g., below a threshold). The AI/ML system 258 may analyze historical and real-time data to identify network paths with (e.g., minimal or) no delay so as to ensure that video packets are delivered promptly to maintain the quality of the video stream. Similarly, in applications where packet loss needs to be reduced or minimized, such as in remote health monitoring, the AI/ML system 258 may select network resources with a proven track record of low packet loss rates. This ensures that critical health data is transmitted reliably without significant data loss. In another example, for applications that are sensitive to jitter, such as Voice over IP (VoIP) services, the AI/ML system 258 may identify and select network paths that exhibit consistent and stable transmission characteristics. By reducing jitter, the AI/ML system 258 can ensure that voice packets are delivered in a smooth and orderly manner. By considering these KPIs, the AI/ML system 258 can make informed decisions to improve (or optimize or approximately optimize) network resource allocation and service delivery for the given mIoT application.

The IoT service endpoint 260 may include one or more computing devices or servers that are configured to process and manage data relating to mIoT devices 205. The IoT service endpoint 260 may serve as a centralized destination for IoT device-related data packets, acting as an IoT service provider that aggregates, processes, and forwards data to the appropriate services or applications. For example, an electric utility company may use the IoT service endpoint 260 to collect data from electric meter devices 205. This centralized approach ensures that data from mIoT devices is efficiently managed and utilized, thereby optimizing or approximately optimizing network performance and scalability. By aggregating data from numerous meter devices 205, the electric utility company can perform various functions, such as monitoring, billing, and analytics for electricity usage.

The following is a description of an example of the SMO system 250's handling of a service request, illustrating a step-by-step process of the SMO system 250's leveraging of the various abstraction layers and intelligent controllers to efficiently manage and deliver the service. Assume that the SMO system 250 receives a service request from the IoT service endpoint 260 to facilitate packet delivery between mIoT devices 205 and the IoT service endpoint 260.

The SMO system 250 may communicate with the AIC 214 to allocate physical resources in the access network(s) 210 for the requested service. The AIC 214 may interact with the access resource abstraction layer to identify the available physical/logical resources. For instance, the access resource abstraction layer may provide abstractions of the various physical/logical resources 210r/210g in the form of universal resource ports 212p. The AIC 214 may use information associated with these universal resource ports 212p, such data regarding resource name, location, capabilities, etc., to dynamically select the physical/logical resources that meet the SMO system 250's request. In particular, one or more xApps 214x in the AIC 214 may analyze the service requirements and provide results of the analysis to the AI/ML system 214a. The xApp(s) 214x may use one or more algorithms or policies to evaluate the specific needs of the service, such as bandwidth, latency, and quality of service QoS requirements. By understanding the service requirements, the xApp(s) 214x can ensure that the AI/ML system 214a has sufficient information to make an informed decision. The AI/ML system 214a may then use the analysis results as well as the information regarding the universal resource ports 212p, including their associated data, to select physical/logical resources for the service. The AI/ML system 214a may evaluate factors such as resource capacity, current load, and compatibility with the service requirements. In this way, the AIC 214 may suggest one or more universal resource ports 212p to the SMO system 250 for use with handling the service request and/or may derive a routing path involving selected universal resource ports 212p for use by the SMO system 250.

The SMO system 250 may additionally, or alternatively, communicate with the TIC 224 to allocate physical resources in the transport network(s) 220 for the requested service. The TIC 224 may interact with the transport resource abstraction layer to identify the available physical resources. For instance, the transport resource abstraction layer may provide abstractions of the various physical resources in the form of universal physical resource ports. The TIC 224 may use information associated with these universal physical resource ports, such as data regarding resource name, location, capabilities, etc., to dynamically select the physical resources that meet the SMO system 250's request. In particular, one or more xApps 224x in the TIC 224 may analyze the service requirements and provide results of the analysis to the AI/ML system 224a. The xApp(s) 224x may use one or more algorithms or policies to evaluate the specific needs of the service, such as bandwidth, latency, and QoS requirements. By understanding the service requirements, the xApp(s) 224x can ensure that the AI/ML system 224a has sufficient information to make an informed decision. The AI/ML system 224a may then use the analysis results as well as the information regarding the universal physical resource ports, including their associated data, to select physical resources for the service. The AI/ML system 224a may evaluate factors such as resource capacity, current load, and compatibility with the service requirements. In this way, the TIC 224 may suggest one or more universal physical resource ports to the SMO system 250 for use with handling the service request and/or may derive a routing path involving selected universal physical resource ports for use by the SMO system 250.

The SMO system 250 may additionally, or alternatively, communicate with the CIC 234 to allocate physical resources in the core network(s) 230 for the requested service. The CIC 234 may interact with the core resource abstraction layer to identify the available physical resources. For instance, the core resource abstraction layer may provide abstractions of the various physical resources in the form of universal physical resource ports. The CIC 234 may use information associated with these universal physical resource ports, such as data regarding resource name, location, capabilities, etc., to dynamically select the physical resources that meet the SMO system 250's request. In particular, one or more xApps 234x in the CIC 234 may analyze the service requirements and provide results of the analysis to the AI/ML system 234a. The xApp(s) 234x may use one or more algorithms or policies to evaluate the specific needs of the service, such as bandwidth, latency, and QoS requirements. By understanding the service requirements, the xApp(s) 234x can ensure that the AI/ML system 234a has sufficient information to make an informed decision. The AI/ML system 234a may then use the analysis results as well as the information regarding the universal physical resource ports, including their associated data, to select physical resources for the service. The AI/ML system 234a may evaluate factors such as resource capacity, current load, and compatibility with the service requirements. In this way, the CIC 234 may suggest one or more universal physical resource ports to the SMO system 250 for use with handling the service request and/or may derive a routing path involving selected universal physical resource ports for use by the SMO system 250.

Based on communications with the AIC 214, the TIC 224, and/or the CIC 234, the SMO system 250 may dynamically select and chain resources across the various networks to provide the service. In various embodiments, the SMO system 250 may continuously monitor the service delivery, using the network data collection, management, and control block 256 to gather real-time information about resource availability and performance. This allows the SMO system 250 to make dynamic adjustments as needed, by communicating with the AIC 214, the TIC 224, and/or the CIC 234 for updates on suggested universal physical resource ports, so as to facilitate seamless and high-quality service delivery for the mIoT application. By leveraging the abstraction layers and intelligent controllers, the SMO system 250 thus provides a flexible, unified, and interoperable network architecture that is capable of efficiently handling complex service requests.

The following is a description of an example process involving control plane traffic in the system 200 of FIG. 2A. At 271, the CLmIoT rApp 252 of the SMO system 250 may identify E2E service delivery and feature requirements (e.g., F1, F2) for an mIoT application so as to facilitate instantiation of features and/or functions (e.g., F1, F2, etc.) at the service edge. In various embodiments, the CLmIoT rApp 252 may identify these requirements in coordination with the AI/ML system 258. The features or functions may include, for instance, data processing, security functions, or specific application logic that are needed for the mIoT application.

At 272, the SMO system 250, such as the network data collection, management, and control block 256, may obtain data from the AIC 214, TIC 224, and/or CIC 234 regarding their respective networks, which may include xApp catalog information. The CLmIoT rApp 252 may use the collected data to create Segment Routing Headers (SRH). An SRH may be a header that can be added to data packets, and may include routing information and service chaining instructions that enable the packets to be forwarded through the network without the need for establishing dedicated connections. For example, an SRH may include information such as intermediate node identifiers and specific xApp identifiers of one or more of intermediate nodes that are needed to process the packets.

The CLmIoT rApp 252 may analyze the data to determine (e.g., real-time) network conditions, and utilize results of the analysis to determine (e.g., the best) routing and service chaining for the mIoT devices 205. The CLmIoT rApp 252 may also sync or communicate with the AIC 214, TIC 224, and/or CIC 234 regarding the service catalog for features that are available to support mIoT device treatment (e.g., security, billing, data analysis, etc.).

At 273, the SMO system 250, such as the service orchestrations and network optimization block 254, may map the identified service requirements to specific xApp(s), chain services for mIoT using the mapped xApp(s), and provide SRH instructions for routing based on TIC and CIC network conditions.

The CLmIoT rApp 252 may provide SRH guidance, considering factors such as 5G core vs. 6G core and wireline vs. wireless transport based on RAN, transport, and core network conditions. Service chaining may be based on service orchestration maps, such as (F1, F2) to (xApp1, xApp2).

In exemplary embodiments, the CLmIoT rApp 252 may generate or create an SRH in accordance with SRv6, which leverages the IPv6 address space to implement segment routing. In SRv6, each segment is represented as an IPv6 address, and the SRH may be used to list such segments. The SRH may contain a list of segment identifiers (SIDs) (i.e., IPv6 addresses) that represent specific network functions or nodes. As a packet traverses the network, each node may process the SRH to determine the next segment and may forward the packet accordingly. By embedding these SIDs directly into the SRH, the nodes in the network can forward the packet through the specified segments without the need for establishing dedicated connection(s).

At 274, the SMO system 250 may cause the CIC 234 to instantiate the needed capabilities that meet the service requirements. In this way, the CIC 234 may instantiate the necessary features (e.g., xApp1, xApp2) at the service edge to meet the service requirements.

At 275, the SMO system 250 may instruct the AIC 214 to add the SRH to packets that are associated with (i.e., transmitted by) the mIoT devices 205. The packets may include a destination address (DA), such as the address S1 of the IoT service endpoint 260. The SMO system 250 may inform the AIC 214 regarding the SRH guidance, such as by including an instruction to the AIC 214 that the SRH be added to the packets. The SRH may identify the transport node/core node and service chaining. For instance, in a case where a hub node T1 (i.e., transport network #1), a core node C2 (i.e., core network #2), and xApps 1 and 2 in the CIC 234 are selected by the CLmIoT rApp 252 and/or the AI/ML system 258, the SRH may identify T1 and C2 as well as xApp1 and xApp2. In this way, a single SRH may be created for all the mIoT devices 205 whose packets specify the same DA (e.g., S1).

At 276, the AIC 214 may instruct an access node (e.g., gNB) that receives packets from the mIoT devices 205 to add the SRH to such packets.

The following is a description of an example process involving data plane traffic in the system 200 of FIG. 2A. At 281, an mIoT device 205 may send a data packet with DA S1 to a gNB (e.g., over an existing air interface). This process may not require any changes to the air interface or the mIoT device 205.

At 282, the gNB may add the SRH to the packet. As described above with respect to step 275, the SRH may include routing information and service chaining instructions that enable the packet to be forwarded through the network without the need for establishing dedicated connection(s).

At 283, the gNB may forward the packet per the SRH to the transport node T1.

At 284, the transport node T1 may update the SRH by removing the T1 routing information from the SRH. The SRH of the resulting packet may then (e.g., only) include routing information for core node C2 and relevant xApps in the CIC 234.

At 285, the transport node T1 may forward the packet to the core node C2 based on the updated SRH.

At 286, the core node C2 may remove the C2 routing information from the SRH. The core node C2 may forward the packet to the CIC 234 for xApp1 and xApp2 therein to provide service treatment for the packet. The CIC 234 may process the SRH of the packet to identify that xApp1 and xApp2 are to be utilized to treat the packet. These xApps may perform the necessary service functions, such as data processing, security checks, etc. After the service treatment is complete, the treated packet may then return to the core node C2, which may remove the xApp1 and xApp2 information (or essentially the entire SRH) from the packet. In this way, intermediate nodes may continue to update the SRH as needed until the packet reaches the final node.

At 287, the core node C2 may then forward the (now SRH-less) packet to the IoT service endpoint 260 as the final destination.

In various embodiments, the CLmIoT rApp 252 may be capable of updating an SRH based on changes in network conditions or resource availability so as to ensure seamless service delivery. For instance, in the foregoing example, consider a scenario where the SMO system 250 receives data from the CIC 234 indicating that core node C2 is experiencing high load or has encountered a fault, making it incapable of handling additional traffic efficiently. In this scenario, the CLmIoT rApp 252 may, in conjunction with the AI/ML system 258, identify an alternative core resource, such as core node C1 (5GC), to be used to facilitate the service for the mIoT application. The CLmIoT rApp 252 may update the SRH to reflect this new selection, and may provide the updated SRH to the AIC 214. The AIC 214 may then instruct the gNB to add this updated SRH to packets associated with the mIoT devices 205 so that the packets end up being routed through the newly-selected core node C1.

By way of the CLmIoT rApp 252, therefore, the SMO system 250 may dynamically manage and optimize (or approximately optimize) the network for mIoT devices by leveraging AI/ML for real-time network condition analysis. The SMO system 250 may compose and instantiate features (e.g., F1, F2) to meet specific service requirements, which ensures efficient and scalable support for mIoT deployments in 6G networks and beyond.

It is to be understood and appreciated that, although FIG. 2A might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various systems, devices, components, modules, applications, layers, networks, etc. may have been illustrated in FIG. 2A as separate systems, devices, components, modules, applications, layers, networks, etc., it will be appreciated that multiple systems, devices, components, modules, applications, layers, networks, etc. can be implemented as a single system, device, component, module, application, layer, network, etc., or a single system, device, component, module, application, layer, network, etc. can be implemented as multiple systems, devices, components, modules, applications, layers, networks, etc. Additionally, functions described as being performed by one system, device, component, module, application, layer, network, etc. may be performed by multiple systems, devices, components, modules, applications, layers, networks, etc., or functions described as being performed by multiple systems, devices, components, modules, applications, layers, networks, etc. may be performed by a single system, device, component, module, application, layer, network, etc.

FIG. 2B depicts an illustrative embodiment of a method 290 in accordance with various aspects described herein.

At 290a, the method can include receiving a service request relating to an mIoT application. For example, the SMO system 250 can, similar to that described above with respect to the system 200 of FIG. 2A, perform one or more operations that include receiving a service request relating to an mIoT application.

At 290b, the method can include identifying service delivery requirements and feature requirements for the service request, resulting in identified requirements. For example, the SMO system 250, such as the CLmIoT rApp 252, can, similar to that described above with respect to the system 200 of FIG. 2A, perform one or more operations that include identifying service delivery requirements and feature requirements for the service request, resulting in identified requirements.

At 290c, the method can include obtaining first information from an AIC regarding resources in one or more access networks, second information from a TIC regarding resources in one or more transport networks, and third information from a CIC regarding resources in one or more core networks. For example, the SMO system 250 can, similar to that described above with respect to the system 200 of FIG. 2A, perform one or more operations that include obtaining network-related data from the AIC 214 regarding resources in one or more access networks 210, network-related data from the TIC 224 regarding resources in one or more transport networks 220, and network-related data from the CIC 234 regarding resources in one or more core networks 230.

At 290d, the method can include based on the identified requirements, the first information, the second information, and the third information, selecting a first resource in the one or more access networks, a second resource in the one or more transport networks, a third resource in the one or more core networks, and at least one treatment function. For example, the SMO system 250, such as the CLmIoT rApp 252, can, similar to that described above with respect to the system 200 of FIG. 2A, perform one or more operations that include based on the identified requirements, the access network resource data, the transport network resource data, and the core network resource data, selecting a first physical/logical resource in the one or more access networks 210, a second physical resource in the one or more transport networks 220, a third physical resource in the one or more core networks 230, and at least one treatment function, such as particular processing provided by xApp(s) in the AIC 214, the TIC 224, and/or the CIC 234.

At 290e, the method can include generating an SRH that identifies the first, second, and third resources and the at least one treatment function. For example, the SMO system 250, such as the CLmIoT rApp 252, can, similar to that described above with respect to the system 200 of FIG. 2A, perform one or more operations that include generating an SRH that identifies the first physical/logical resource, the second physical resource, and the third physical resource and the at least one treatment function.

At 290f, the method can include causing the SRH to be provided to the AIC to facilitate embedding of the SRH into packets relating to the mIoT application, thereby enabling connectionless E2E service delivery for the mIoT application. For example, the SMO system 250, such as the CLmIoT rApp 252, can, similar to that described above with respect to the system 200 of FIG. 2A, perform one or more operations that include causing the SRH to be provided to the AIC 214 to facilitate embedding of the SRH into packets relating to the mIoT application, thereby enabling connectionless E2E service delivery for the mIoT application.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

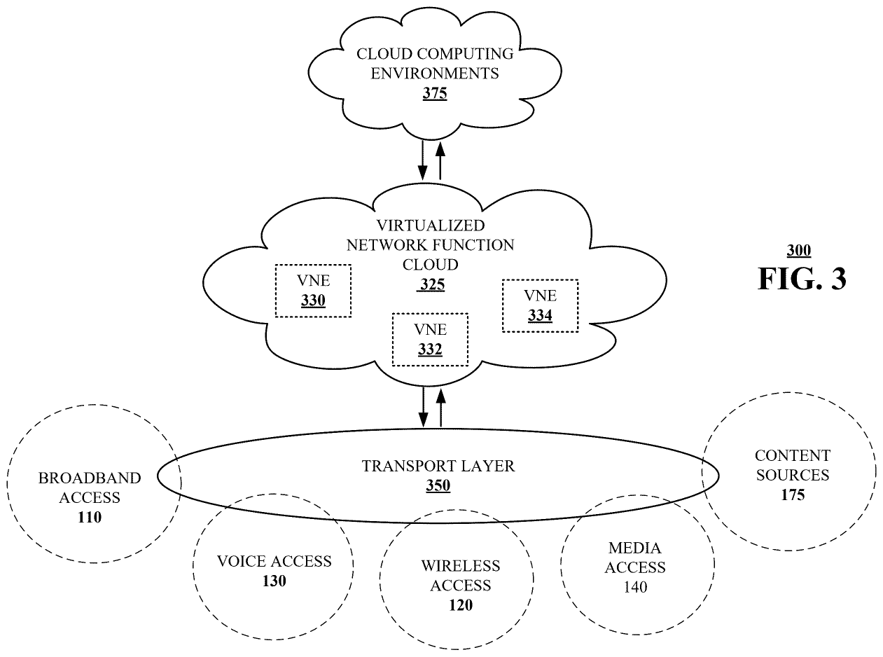

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and method 290 presented in FIGS. 1, 2A, and 2B. For example, virtualized communications network 300 can facilitate, in whole or in part, intelligence-based connectionless packet/service delivery for mIoT applications.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers - each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

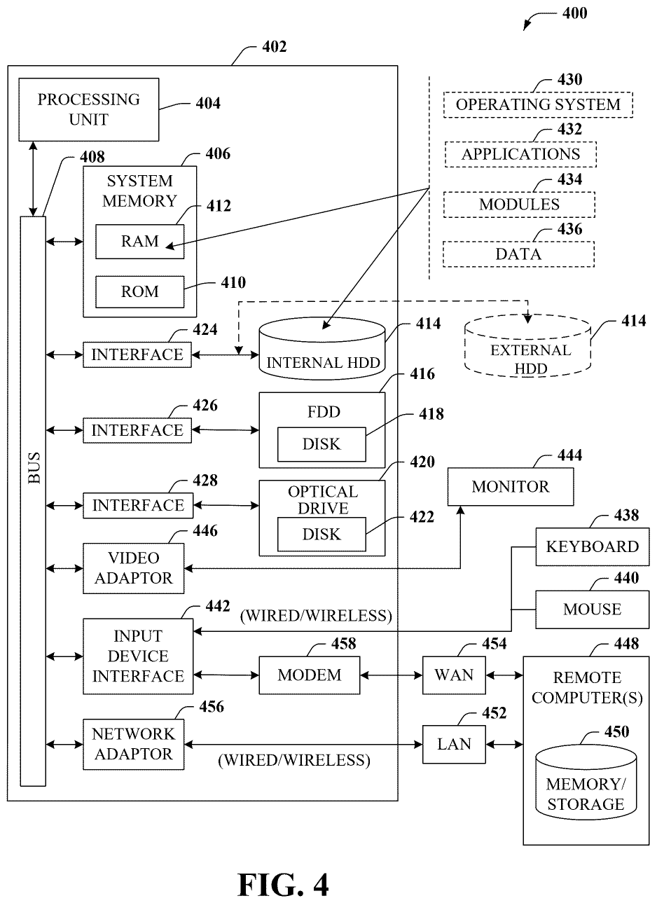

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, intelligence-based connectionless packet/service delivery for mIoT applications.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

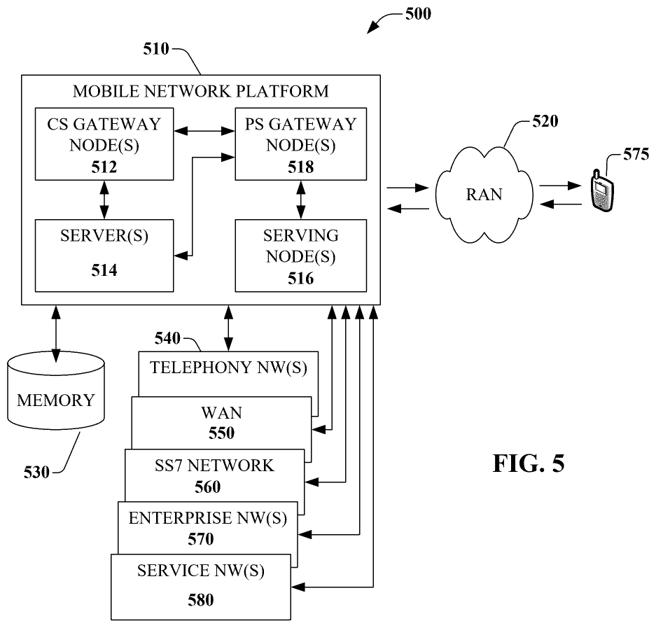

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, intelligence-based connectionless packet/service delivery for mIoT applications. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

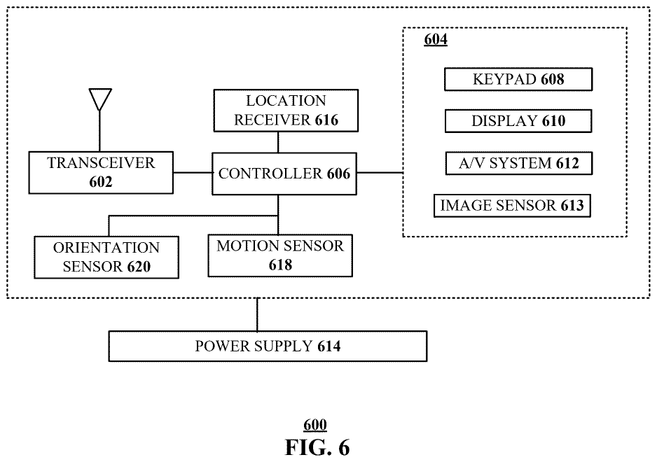

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, intelligence-based connectionless packet/service delivery for mIoT applications.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
receiving a service request relating to a massive Internet-of-Things (mIoT) application;
identifying service delivery requirements and feature requirements for the service request, resulting in identified requirements;
obtaining first information from an access intelligent controller (AIC) regarding resources in one or more access networks, second information from a transport intelligent controller (TIC) regarding resources in one or more transport networks, and third information from a core intelligent controller (CIC) regarding resources in one or more core networks;
based on the identified requirements, the first information, the second information, and the third information, selecting a first resource in the one or more access networks, a second resource in the one or more transport networks, a third resource in the one or more core networks, and at least one treatment function;
generating a segment router header (SRH) that identifies the first, second, and third resources and the at least one treatment function; and
causing the SRH to be provided to the AIC to facilitate embedding of the SRH into packets relating to the mIoT application, thereby enabling connectionless end-to-end (E2E) service delivery for the mIoT application.

2. The device of claim 1, wherein the receiving comprises receiving the service request from a service endpoint that is associated with a plurality of mIoT devices.

3. The device of claim 1, wherein the first information, the second information, or the third information comprises data regarding network conditions, resource availability, resource capabilities, or a combination thereof.

4. The device of claim 1, wherein the embedding of the SRH is performed by the first resource.

5. The device of claim 1, wherein the selecting involves use of an artificial intelligence (AI) model that is trained to recommend resources for satisfying service delivery requirements.

6. The device of claim 1, wherein the selecting involves use of an artificial intelligence (AI) model that is trained to recommend treatment functions for satisfying feature requirements.

7. The device of claim 1, wherein the at least one treatment function comprises particular processing for the packets relating to the mIoT application.

8. The device of claim 7, wherein the particular processing is implemented in an xApp.

9. The device of claim 8, wherein the xApp is included in the AIC, the TIC, or the CIC.

10. The device of claim 1, wherein the SRH is generated in accordance with Segment Routing over Internet Protocol (IP)v6 (SRv6).

11. The device of claim 1, wherein the at least one treatment function comprises particular processing that is implemented in the CIC.

12. The device of claim 11, wherein the causing enables the first resource to:
remove an identifier of the first resource from the SRH of one or more of the packets, resulting in one or more first updated packets; and
forward the one or more first updated packets to the second resource.

13. The device of claim 12, wherein the causing further enables the second resource to:
remove an identifier of the second resource from the SRH of one or more of the one or more first updated packets, resulting in one or more second updated packets; and
forward the one or more second updated packets to the third resource.

14. The device of claim 13, wherein the causing further enables the third resource to:
remove an identifier of the third resource from the SRH of one or more of the one or more second updated packets, resulting in one or more third updated packets;
transmit the one or more third updated packets to the CIC for the particular processing;
receive one or more processed packets from the CIC after the particular processing; and
forward the one or more processed packets to a service endpoint.

15. A non-transitory machine-readable medium, comprising executable instructions that, when executed by a processing system including a processor, facilitate performance of operations, the operations comprising:
receiving a service request relating to a massive Internet-of-Things (mIoT) application;
identifying end-to-end (E2E) service delivery requirements for the service request, resulting in identified requirements;
obtaining information from a plurality of network controllers regarding resources in a plurality of networks associated with the plurality of network controllers;
based on the identified requirements and the information, selecting at least one treatment function and a plurality of resources in the plurality of networks;
generating a segment router header (SRH) that identifies the at least one treatment function and the plurality of resources; and
transmitting the SRH to a first network controller of the plurality of network controllers, wherein the transmitting causes the first network controller to instruct a first resource of the plurality of resources to add the SRH to packets relating to the mIoT application so as to enable connectionless E2E service delivery for the mIoT application.

16. The non-transitory machine-readable medium of claim 15, wherein the at least one treatment function comprises particular processing for the packets relating to the mIoT application.

17. The non-transitory machine-readable medium of claim 16, wherein the particular processing is implemented in an xApp.

18. The non-transitory machine-readable medium of claim 15, wherein the SRH is generated in accordance with Segment Routing over Internet Protocol (IP)v6 (SRv6).

19. A method, comprising:
providing, by a processing system including a processor, and to a service management and orchestration (SMO) system, information regarding resources in one or more networks;
based on the providing, receiving, by the processing system and from the SMO system, a segment router header (SRH) that identifies at least one treatment function and a plurality of resources,
wherein the plurality of resources includes one or more resources in the one or more networks and one or more other resources in one or more other networks,
wherein the at least one treatment function is implemented in the processing system or another processing system, and
wherein the SRH is generated by the SMO system according to the information and according to service requirements and feature requirements for a service request relating to a massive Internet-of-Things (mIoT) application; and
responsive to the receiving, instructing, by the processing system, a first resource of the plurality of resources to embed the SRH into packets relating to the mIoT application, thereby enabling connectionless end-to-end (E2E) service delivery for the mIoT application.

20. The method of claim 19, wherein the one or more networks comprise one or more access networks, wherein the first resource comprises a physical resource in the one or more access networks, and wherein the processing system comprises an access network controller.
